(19) United States
(12) Patent Application Publication
(10) Pub. No.: US 2007/0261713 A1
(43) Pub. Date: Nov. 15, 2007

(54) Transmitting/Receiving Device for Washing Machine and Apparatus and Method Thereof

(75) Inventors: Seung Bong Choi, Gyeongsangnam-do (KR); Youngsoo Kim, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS, INC., Youngdungpo-gu (KR)

(21) Appl. No.: 10/556,215

(22) PCT Filed: Jul. 18, 2005
(86) PCT No.: PCT/KR05/02296

§ 371 Date: Apr. 2, 2007

(30) Foreign Application Priority Data
Aug. 30, 2004 (KR) P 2004-68439

(51) Int. Cl. B08B 7/04; D06F 29/00; G08B 13/14

(52) U.S. Cl. 134/18; 340/572.1; 340/572.8; 68/13 R

(57) ABSTRACT

The present invention relates to washing apparatuses and washing methods, more particularly, to an information transceiver of a new structure for a washing apparatus, for making automatic determination of kinds of laundry introduced to an inside of a drum, and differential determination of washing environments with reference to determined information, for making smooth wash of the laundry.

### TECHNICAL FIELD

The present invention relates to washing apparatuses and washing methods, and more particularly, to an information transceiver of a new structure for a washing machine, which can identify a kind of clothes being introduced into a drum automatically, to enable optimal washing, or progressing of various cycles, and washing apparatus and method having the information transceiver applied thereto.

### BACKGROUND ART

In general, in the washing apparatuses, there are pulsator type washing machines each having a vertical drum, drum type washing machines each having a drum laid down in a horizontal direction, and washing and drying machines each having a drying function.

The washing apparatus performs washing by determining an amount of laundry introduced to the drum, and setting a washing water level and a washing time period automatically according to the amount of laundry.

The amount of laundry introduced to the drum is determined with a weight sensor or by measuring a load on a driving motor.

However, in the laundry amount determining method, only weight of entire laundry is determined, but failed to determine a water level of washing water proper to the properties of pieces of laundry.

Particularly, taking a fact into account that, of the properties of the pieces of laundry, the water level can vary substantially with water absorption ratios of the pieces of laundry, if the water level is determined in a state the water absorption ratios are not taken into account, performance of an optimal washing is not possible.

Recently, owing to development of information technology, a RFID (Radio Frequency Identification) Tag is attached to a portion of clothes for making management of logistics or management of information possible.

The RFID tag has a predetermined memory region for enabling memory of various kinds of information on the clothes. The memory region has various kinds of information recorded thereon, or is a kind of memory chip for enabling recording of additional information.

However, the information in the RFID tag on the clothes is used only for logistics of the clothes merely, but failed to apply to a washing cycle.

Of course, Korean Registered Patent Publication No. P1995-0011598 discloses a washing information input device provided with an information medium attached to clothes, having information on washing recorded thereon, washing information input sensing means mounted to an appropriate place of a body of a washing machine for sensing the washing information on the information media, and system control means for controlling entire system operation of the washing machine by using the washing information sensed at the washing information input sensing means.

That is, the Korean Registered Patent Publication No. P1995-0011598 enables to obtain information on washing from the information media attached to clothes and to perform an appropriate washing according to the information on washing.

Japanese Laid Open Patent No. 2002-360968 discloses a washing apparatus in which a noncontact identification device is used, provided with a reader for receiving a signal from the RFID tag to be attached to clothes and having information recorded thereon, a central information processing unit having a holder for informing information the reader reads, and a control unit for setting or changing a washing mode.

That is, the Japanese Laid Open Patent No. 2002-360968 intends to obtain information on washing from the RFID tag attached to the clothes at the time of washing, for preventing setting of an improper washing.

However, the related arts, only determining total weight of clothes for fixing a water level, have failed in controlling the water level for optimal washing.

Moreover, when clothes having the RFID tag attached thereto is being introduced into the drum, the related arts require that the RFID tag is brought close to the reader and register one by one in succession, for making information on the RFID tag read.

This is because, considering that a RF signal can not transmit metal, there can be left out of information due to failure of obtaining information from overlapped RFID tags, or the RFID tag covered with a coin or the like at the time of obtaining the information from clothes introduced in the drum.

Of course, an electromagnetic wave type RF antenna may be used for making a long range radio contact between the RFID tag and the reader possible.

However, the electromagnetic wave type RF antenna, not only is expensive, but also causes an error as the reader even reads information on clothes the user wears during the user introduces laundry into the washing apparatus.

Moreover, since the related art reader and register for obtaining information from the RFID tag is required to be mounted to a place where the washing water is not liable to be brought into contact, the mounting place is limited.

Furthermore, the related arts can only give a notice that washing is not possible if different kinds of clothes are introduced into the drum.

That is, because the related arts can not wash different kinds of clothes at a time, washing is made separately for each kind of clothes, to require a longer total washing time period.

### DISCLOSURE

### TECHNICAL PROBLEM

An object of the present invention is to provide new washing apparatus and method, in which a water level of washing water is determined, varied with properties of laundry introduced into a drum; for performing optimal washing.

Another object of the present invention is to provide new washing method, in which kinds of pieces of laundry introduced into a drum can be identified automatically, and enables optimal washing even if different kinds of pieces of laundry is introduced.

Another object of the present invention is to provide an information transceiver for a washing apparatus, which can obtain information on laundry by a noncontact system, controls to make an appropriate washing according to the obtained information, and has a system optimized to an environment of the washing apparatus.

Another object of the present invention is to provide a washing apparatus of a new structure, which can make automatic washing with reference to information obtained from laundry introduced into a drum by using a noncontact system, can make exact identification of the laundry, and can prevent water from infiltrating into a RF reader unit.

Further object of the present invention is to provide a method for controlling a washing apparatus, in which information on laundry can be obtained at a time without left out of information caused by sensing error in a state laundry is introduced in a drum in advance.

### TECHNICAL SOLUTION

The objects of the present invention can be achieved by providing an information transceiver for a washing apparatus including a RFID Tag (Radio Frequency Identification Tag) fastened to a portion of each piece of laundry, the RFID Tag having information on the piece of laundry stored therein, a RF reader unit mounted to a portion of the washing apparatus, for transmitting/receiving information to/from the pieces of laundry introduced to the washing apparatus at a time by a mutual induction system, and a control unit for performing setting of at least one cycle of washing operation with reference to various kinds of information on the laundry received from the RF reader unit.

In a first mode of the present invention for achieving the objects of the present invention, a washing apparatus includes a reader unit for receiving a signal from an information tag on each piece of laundry, to obtain information on washing the piece of laundry stored in the information tag, and a control unit for performing setting of at least one cycle of washing operation with reference to the information on washing the piece of laundry obtained from the reader unit, and controlling to perform washing according to a set cycle.

In a second mode of the present invention for achieving the objects of the present invention, a washing apparatus includes a body forming an exterior, the body having an opening, a drum rotatably mounted in the body, the drum having an opening for introducing laundry thereto, a door unit for closing the opening, having at least a portion formed of non-metallic material, and a RF reader unit mounted on a non-metallic portion of the door unit, for obtaining information from a RFID tag on each piece of laundry transmitting through the door unit.

In a third mode of the present invention for achieving the objects of the present invention, a washing apparatus includes a body forming an exterior, the body having an opening, a drum rotatably mounted in the body, the drum having an opening for introducing laundry thereto, a door unit for closing the opening, a rim portion of non-metallic material between the opening in the body and the opening in the drum for closing a gap between the drum and the inside of the body, and a RF reader unit mounted on an inside of the body, for obtaining information from a RFID tag on each piece of laundry transmitting through the rim portion.

In a first mode of the present invention for achieving the objects of the present invention, a washing method includes an information obtaining step for obtaining information on a weight and a water absorption ratio of a piece of laundry from an information tag on the piece of laundry introduced to the drum by using a reader unit, a water level determining step for determining a water level with reference to the information obtained thus, and a cycle performing step for performing washing related cycles at the washing level in succession.

In a second mode of the present invention for achieving the objects of the present invention, a washing method includes a laundry introducing step for introducing laundry to an inside of a drum, a drum rotating step for rotating the drum, and an information obtaining step for putting a reader unit into operation to obtain various kinds of information from an information tag on each piece of laundry in a drum which is rotating.

In another mode of the present invention for achieving the objects of the present invention, a washing method includes a laundry introducing step for introducing laundry to an inside of a drum, an information determining step for putting a reader unit into operation to determine whether predetermined sensing finish information is stored in the tag of each piece of laundry introduced to an inside of drum, and if no sensing finish information is stored therein, information on washing of the piece of laundry is obtained from the information tag, and the sensing finish information is provided thereto.

In a third mode of the present invention for achieving the objects of the present invention, a washing method includes an information obtaining step for obtaining information on washing pieces of laundry from each information tag on each of the pieces of laundry introduced to an inside of a drum, an operation setting step for setting operation of each cycle for washing entire pieces of laundry at a time with reference to information on washing obtained thus, and performing washing in an order of operation cycles set thus.

In a fourth mode of the present invention for achieving the objects of the present invention, a washing method includes an information obtaining step for obtaining information on washing pieces of laundry from each information tag on each of the pieces of laundry introduced to an inside of a drum, a classifying step for classifying the pieces of laundry into similar kinds with reference to the information on washing obtained thus, an operation order setting step for setting an order of operation of each cycle such that the cycles are performed in an order of the kinds of pieces of laundry classified thus of which cycle time periods are the shorter, or cycle temperatures are the lower in succession, and performing cycles in an order of operation cycles set thus.

In a fifth mode of the present invention for achieving the objects of the present invention, a washing method includes an information obtaining step for obtaining information on washing pieces of laundry from each information tag on each of the pieces of laundry introduced to an inside of a drum, a classifying step for classifying the pieces of laundry into similar kinds with reference to the information on washing obtained thus, a washing amount determining step for determining amounts of pieces of laundry classified into similar kinds, an operation setting step for making differential setting of cycle time periods or cycle temperatures according to the amounts of the pieces of laundry classified into similar kinds determined thus, and a cycle performing step for performing cycles in an order of operation cycles set thus.

### ADVANTAGEOUS EFFECTS

The information transceiver for a washing apparatus in accordance with embodiments of the present invention has the following advantages.

First, the availability of obtaining information on washing pieces of laundry at a time even if the pieces of laundry are not brought close to a reader one by one to obtain the information on washing can eliminate inconvenience of users.

Second, the most appropriate application of the RF system having the RFID tag and the RF reader unit at minimum cost permits to prevent a sensing error of laundry the user wears from happing in advance.

Moreover, the washing apparatus in accordance with the first preferred embodiment of the present invention, and the washing methods in accordance with the first to third preferred embodiment of the present invention have the following advantages.

First, the at a time obtaining of information from information tags on pieces of laundry in a state the laundry intended to wash is introduced to an inside of a drum in advance permits to reduce inconvenience of the user in obtaining information.

Second, the control to make a low speed driving of the drum at the time of obtaining information on the pieces of laundry introduced to the inside of the drum permits to prevent left out of sensing caused by overlap of the information tags in advance.

Third, the storing of sensing finish information in the information tag having information obtained therefrom permits to prevent duplicated obtaining of the information, thereby enabling to obtain exact information.

Fourth, the determination of kinds of the pieces of laundry by a non-contact system permits washing of the pieces of laundry class by class.

Fifth, even if various kinds of pieces of laundry are introduced to an inside of the drum mixed with one another, washing can be performed.

Sixth, in a case washing is to be performed in a state various kinds of pieces of laundry are mixed, by setting cycle time periods, cycle temperatures, spinning speeds, and so on to be increased in succession according to classification of the pieces of laundry, the best washing effect can be obtained with a minimum washing time period.

Seventh, the determination of a washing water level taking water absorption ratios of the pieces of laundry into account permits an optimum washing performance, thereby enabling to improve washing efficiency.

Moreover, the washing apparatuses in accordance with the second to fourth preferred embodiments of the present invention have the following advantages.

First, the mounting of a RF reader unit which can avoid a drum of metal through which a RF signal can scarcely transmit, and can prevent infiltration of washing water thereto permits to prevent left out of information of particular error caused by the drum.

Second, the prevention of water infiltration into the RF reader unit permits to prevent damage thereto in advance.

Third, the prevention of sensing the laundry the user wears permits to prevent a sensing error.

### DESCRIPTION OF DRAWINGS

FIG. 1 illustrates a conceptual diagram for describing an information transceiver for a washing apparatus in accordance with a preferred embodiment of the present invention;

FIG. 2 illustrates an exploded perspective view for describing a RFID tag in accordance with a preferred embodiment of the present invention;

FIG. 3 illustrates a conceptual diagram for describing structures of a RFID tag and a RFID reader in accordance with a preferred embodiment of the present invention;

FIG. 4 illustrates a block diagram of a washing apparatus in accordance with a first preferred embodiment of the present invention;

FIG. 5 illustrates a flow chart showing the steps of a process for obtaining information from laundry in a method of using a washing apparatus in accordance with a first preferred embodiment of the present invention;

FIG. 6 illustrates a flow chart showing the steps of a process for preventing obtaining information in duplication in a method of using a washing apparatus in accordance with a first preferred embodiment of the present invention;

FIG. 7 illustrates a flow chart for describing the steps of a washing method in accordance with a first preferred embodiment of the present invention;

FIG. 8 illustrates a flow chart for describing the steps of a process for determining a water level in a method of using a washing apparatus in accordance with a first preferred embodiment of the present invention;

FIG. 9 illustrates a flow chart for describing the steps of a washing method in accordance with a second embodiment of the present invention;

FIGS. 10 to 13 flow charts each for describing the steps of a process for setting operation of one of cycles in a washing method in accordance with a second preferred embodiment of the present invention;

FIG. 14 illustrates a flow chart for describing the steps of a washing method in accordance with a third embodiment of the present invention;

FIG. 15 illustrates a flow chart for describing a variation of the steps of a washing method in accordance with a third preferred embodiment of the present invention;

FIG. 16 illustrates a flow chart for describing the steps of a washing method in accordance with a fourth preferred embodiment of the present invention;

FIG. 17 illustrates a perspective view showing a washing apparatus in accordance with a second preferred embodiment of the present invention;

FIG. 18 illustrates a side section of a washing apparatus in accordance with a second preferred embodiment of the present invention;

FIG. 19 illustrates a perspective view of a washing apparatus in accordance with a third preferred embodiment of the present invention;

FIG. 20 illustrates a key part enlarged section for describing an example of mounting of the RF reader unit in the washing apparatus in accordance with a third preferred embodiment of the present invention; and

FIG. 21 illustrates a key part enlarged section for describing an example of mounting of the RF reader unit in the washing apparatus in accordance with a fourth preferred embodiment of the present invention.

### BEST MODE

Preferred embodiments of the present invention will be described in detail, with reference to the attached drawings.

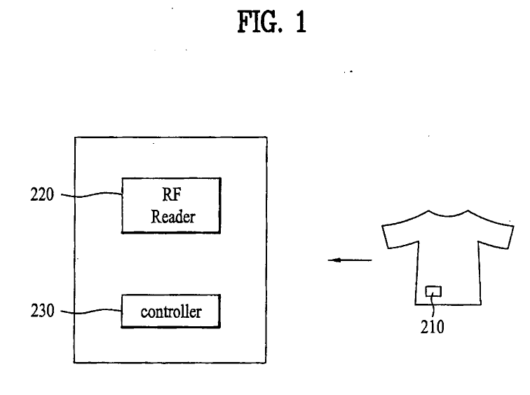

Referring to FIG. 1, the information transceiver for a washing apparatus includes a RFID tag 210, a RF reader unit 220, and a control unit 230.

The RFID tag (Radio Frequency Identification Tag) 210 is fastened to a portion of a piece of laundry, and has various kinds of information on the piece of laundry recorded thereon.

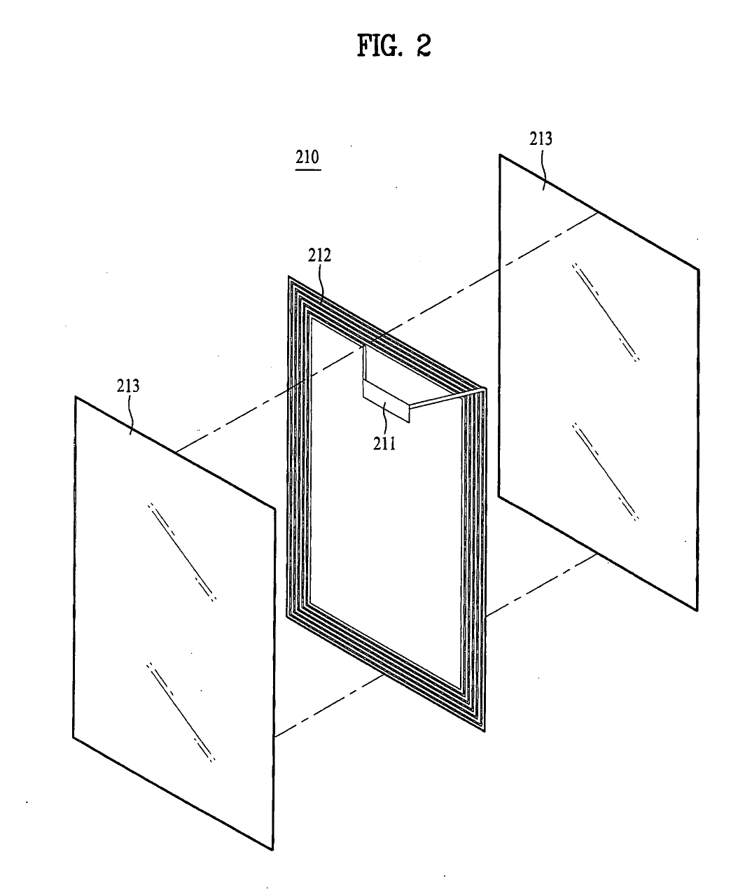

Referring to FIG. 2, the RFID tag 210 preferably includes a RFID chip 211, a coil antenna 212, and water proof films 213.

The RFID chip 211 has various kinds of information stored therein.

The coil antenna 212 emits an information signal stored in the RFID chip 211.

The water proof films 213 enclose both the RFID chip 211 and the coil antenna 212. The water proof films 213 prevent water from infiltrating both to the RFID chip 211 and the coil antenna 212.

Particularly, considering that the RFID tag 210 is attached to the piece of laundry application of power thereto is difficult, it is preferable that the RFID tag 210 is a passive type tag which rectifies an electric wave signal from the RF reader unit 220 for using as a power source.

It is more preferable that the RFID chip 210 of the RFID tag 210 can store information, additionally.

Moreover, it is more preferable that the RFID tag 210 is detachable as the user requires.

Of course, though the RFID tag may be fabricated attached to the laundry in a state information on the laundry is stored therein in a fabricating process of the laundry, the user may also have a piece of laundry the RFID tag 210 is not attached thereto yet.

Therefore, it is preferable that an information left out error of the laundry can be prevented by attaching the RFID tag 210 having information on the laundry stored therein to the laundry having no RFID tag 210 attached thereto, manually.

It is preferable that the RF reader unit 220 is mounted at a position of the washing apparatus within approx. 1 m from a position the laundry is introduced thereto in the drum 120.

Particularly, it is preferable that the RF reader unit 220 is designed to perform information transmission/reception to/from the RFID tag 210 at a time by a mutual induction system.

The RF reader unit 220 has an advantage over the system disclosed by Korea Registered Patent Publication No. P1995-0011598, and Japanese Laid Open Patent Publication No. 2002-360968, in which the laundry is brought close to the reader and register one by one in succession, for obtaining information from the RFID tag 210, in that user's inconvenience can be reduced to the maximum.

That is, the user can obtain information at a time by selecting an operation after introduction of all laundry intended to wash into the washing apparatus, simply.

By realizing the RFID system including the RFID tag 210 and the RF reader unit 220 by the mutual induction system that enables short range information obtainment, price reduction as well as prevention of information sensing error can be achieved.

Of course, a RFID system of an electromagnetic wave system with a RF antenna may be applied to the washing apparatus. However, the active type RFID tag used in the RFID system has a problem of a high total production cost due to the expensive active type RFID tag, and is liable to cause a problem in that the active type RFID tag can obtain information on laundry the user wears too as the active type RFID tag has a long range.

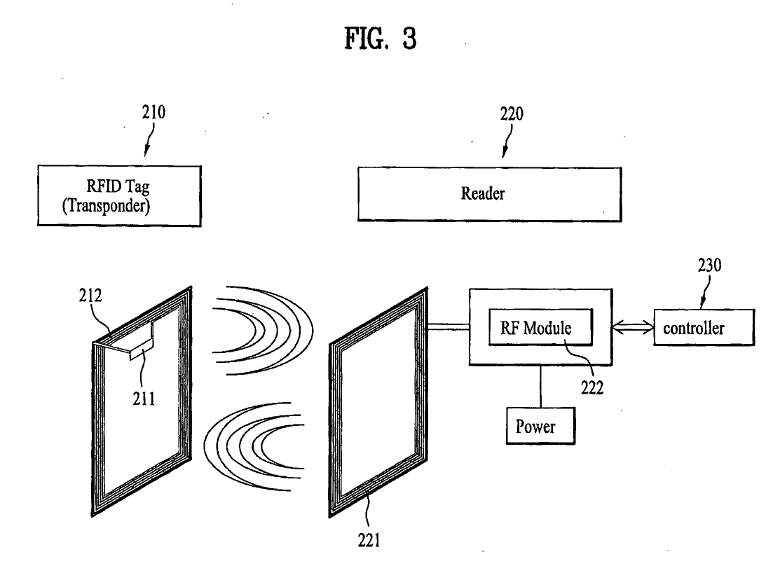

Referring to FIG. 3, the RF reader unit 220 includes a reader antenna 221 for exchanging a signal with the RFID tag 210, and a RF module 222 for analyzing, and integrating information from the RFID tag 210 received through the reader antenna 221.

The control unit 230 sets at least one cycle for making washing operation with reference to various kinds of information on the pieces of laundry received at the RF reader unit 220.

The control unit 230 may be fabricated as one unit with the RF reader unit 220, or separate from the RF reader unit 220.

If the control unit 230 is fabricated as one unit with the RF reader unit 220, it is preferable that the control unit 230 can exchange information with a microcomputer which controls operation of various driving units of the washing apparatus, such as a driving motor, various valves, heaters, and so on.

Opposite to this, if the control unit 230 is fabricated separate from the RF reader unit 220, it is preferable that the control unit 230 is designed to perform a function of the microcomputer, too.

A process of automatic setting of washing operation by means of the information transceiver for a washing apparatus will be described.

The description will proceed based on separate type RF reader 220 and control unit 230.

Upon starting operation after a large number of pieces of laundry is introduced to the washing apparatus, the RF reader unit 220 exchanges signals with the RFID tags 210 attached to the pieces of laundry, to obtain information on washing for all the pieces of laundry at a time.

With regard to the piece of laundry having no RFID tag attached thereto, it is preferable that the user attaches a separate RFID tag 210 having information on the laundry stored therein to the piece of laundry, personally.

It is preferable that the information on the piece of laundry is stored in the RFID tag 210 by operating the control unit 230 or by using a device that can store information in the RFID tag.

Then, the RF reader unit 220 provides the information obtained thus to the control unit 230.

In this instance, the control unit 230 sets control of each cycle of washing based on a table provided thereto in advance with reference to information from the RF reader unit 220.

For an example, if the pieces of laundry introduced to the drum 120 are determined to be as a kind of the pieces of laundry that is liable to deteriorate in a case washing or drying is performed at a high temperature (approx. 60° C. or higher), the washing and drying temperatures are set to be below 60° C., and a washing time period is set accordingly.

Though not shown, once setting of the control is made, the control unit 230 proceeds various cycles as set above by controlling the driving motor for driving the drum, various valves for controlling an amount of washing water to be supplied, and a level of washing water, and heater for controlling the washing temperature or the drying temperature.

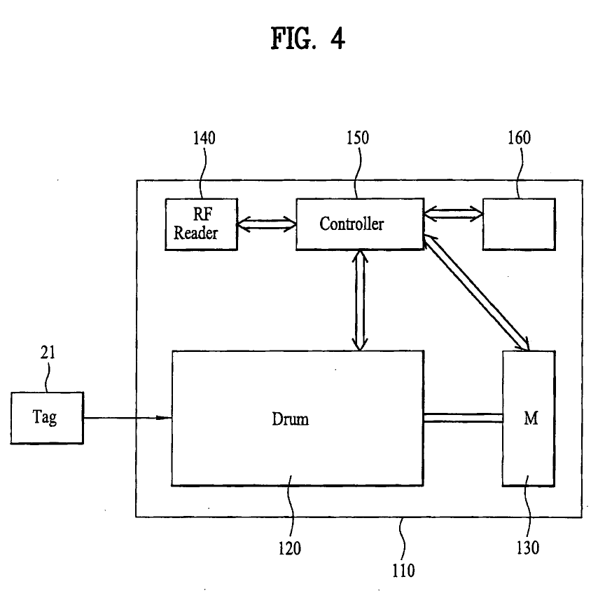

In the meantime, FIG. 4 illustrates a block diagram of a washing apparatus in accordance with a first preferred embodiment of the present invention.

That is, the washing apparatus in accordance with a first preferred embodiment of the present invention has the information transceiver for a washing apparatus applied thereto, which will be described in more detail.

The washing apparatus in accordance with a first preferred embodiment of the present invention includes a body 110, a drum 120, a driving unit 130, a reader unit 140, and a control unit 150.

The body 110 forms an exterior of the washing apparatus.

The drum 120 is mounted in the body 110, and driven by the driving unit 130.

The reader unit 140 obtains information from the information tag 21 attached to the laundry.

The information tag has information on washing of the laundry stored therein, for transmitting/receiving a signal to/from the reader unit 140 to transmit information therefrom or receive new information not stored therein.

It is preferable that the information tag 21 is the RFID tag, and the reader unit 140 is a RFID reader which exchanges a signal with the RFID tag to receive information from the RFID tag, or to write new information on the RFID tag.

Of course, the information tag 21 may have a bar code, and the reader unit 140 may be a bar code reader, or one of other various structures which can exchange information by other noncontact method.

Moreover, the information on washing stored in the information tag 21 on a piece of laundry includes at least one of washing temperature, spinning speed, drying temperature, drying time period, laundry weight, and water absorption ratio.

The control unit 150 controls driving of various driving units 130 of the washing apparatus.

Particularly, it is preferable that the control unit 150 obtains information on all the pieces of laundry introduced to the drum 130 from the reader unit 140.

Along with this, the control unit 150 fixes preferable water levels of each of cycles of washing with reference to information obtained thus, and controls to perform washing related cycles at the fixed water levels.

Moreover, it is preferable that the control unit 150 has water levels for laundry weights set therein in advance, and reference values for water absorption ratios stored therein in advance.

In this instance, it is preferable that stored values are taken as the reference values respectively because a laundry weight and a water weight the laundry absorbs are the same, substantially.

Moreover, it is preferable that the control unit 150 obtains information of all the pieces of laundry introduced to the drum 130 from the reader unit 140, sets a cycle performing order by determining cycles which can be performed in common according to kinds of the pieces of laundry, a cycle performing time period, and a cycle performing temperature, and performs washing by controlling the driving units 130 with reference to the set description.

In the meantime, it is preferable that the washing apparatus of the first embodiment further includes a noticing unit 160 for giving a notice to the user of description of error, or description of instruction.

The noticing unit 160 may be a screen which can display information, such as an LCD window, or a speaker that sounds ‘beep’.

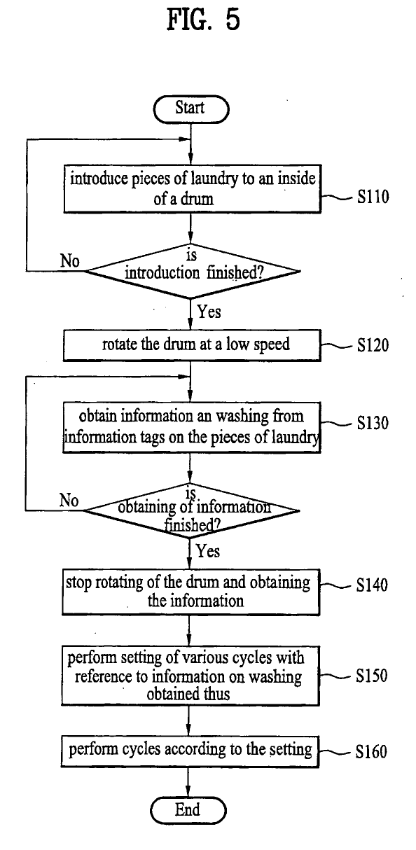

A process for obtaining information on pieces of laundry by using a structure in accordance with a first preferred embodiment of the present invention will be described with reference to the flow chart in FIG. 5.

The user introduces a large number of pieces of laundry intended to wash to a drum 120 (S110).

In this instance, without bringing the information tags 21 of the pieces of laundry close to the reader unit 140, the user introduces all the pieces of laundry to the drum 120 at a time.

Then, once the introduction of pieces of laundry to the drum 120 is finished, the control unit 150 controls the driving unit 130, to rotate the drum 120 (S120).

In this instance, it is preferable that the drum 120 is rotated at a low speed, which is the same or lower than a rotation speed at the time of washing.

If the drum 120 rotates at the low speed, the control unit 150 puts the reader unit 140 into operation, to obtain various kinds of information from the information tags 21 of the pieces of laundry in the drum 120.

The drum 120 is rotated at the low speed because the reader unit 140 is liable to obtain information only from one information tag among overlapped information tags in a case the information tags are overlapped.

By making the pieces of laundry stirred continuously with the continuous low speed rotation of the drum 120, the information obtaining error caused by overlap of the information tags 21 can be prevented.

Upon finishing obtaining information on the pieces of laundry in the drum 120 by above series of steps, the control unit 150 controls the driving unit 130, to stop rotation of the drum 120, as well as the obtaining of information (S140).

Then, the control unit 150 sets various operation cycles with reference to information on washing the pieces of laundry obtained at the reader unit 140 (S150), and controls to perform the cycles according to set description (S160).

In the meantime, the process for obtaining information on the pieces of laundry is liable to obtain information on the laundry of which information is obtained already at the reader unit 140 again.

Of course, though the problem can be solved by setting to prevent obtaining the same information, taking that there can be two or more than two pieces of same kind of laundry into account, there can be left out of information on at least one piece of laundry if two or more than two pieces of same kind of laundry are introduced to the drum 120.

Consequently, the present invention provides a new step for preventing left out of information on a plurality of pieces of same kind of laundry, while preventing obtaining information from the same information tag 21 again, additionally.

Above new step can be achieved by providing predetermined sensing finish information to the information tag 21 having information obtained therefrom in the step for performing obtaining information from the information tags 21.

It is preferable that the sensing finish information may be set with one selected from numerals, characters, signs, or codes.

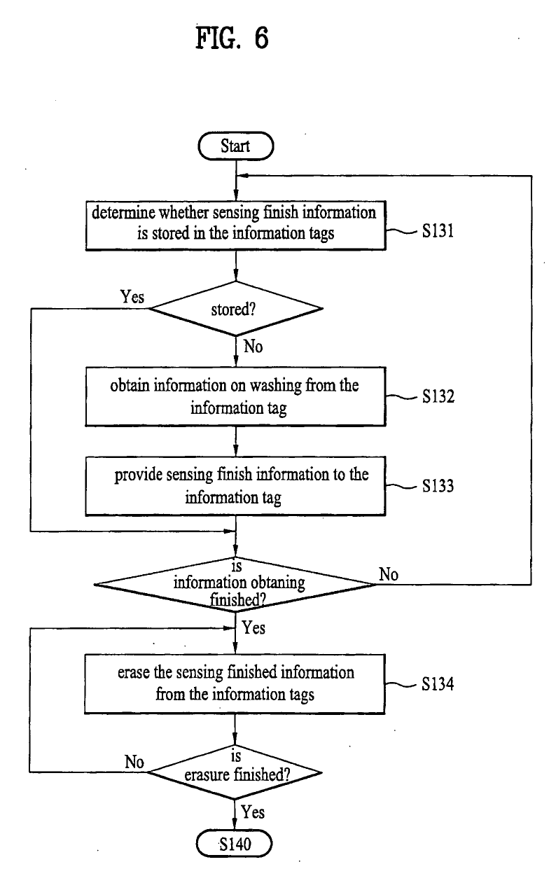

That is, referring to the flow chart in FIG. 6, the information tag 21 is determined whether a predetermined sensing finish information is stored therein or not (S131).

Then, as a result of above determination, if the sensing finish information is stored therein, no information obtaining is performed for the information tag. As the result of above determination, if no sensing finish information is stored therein, information on washing is obtained from the information tag 21 (S132), and the sensing finish information is provided thereto (S133).

Upon finishing obtaining information on the pieces of laundry according to above series of steps, the control unit 150 controls the reader unit 140, to erase the sensing finish information stored in the information tags 10 (S134), for preventing sensing error at a washing step to be performed, later.

Along with this, the control unit 150 performs setting of various cycles for performing washing with reference to information on washing of the pieces of laundry obtained at the reader unit 140, and controls to make the cycles according to set description progressed.

Of course, the control unit 150 may inform the user to take out pieces of laundry of which washing mixed with other laundry is not possible in the middle of determining information on washing of the pieces of laundry obtained at the reader unit 140.

At the end, information on the pieces of laundry introduced to the drum 120 according to above steps can be obtained exactly, and used for washing the pieces of laundry.

Various embodiments of washing methods to be performed depending on various states with reference to information obtainable exactly according to above series of steps will be described.

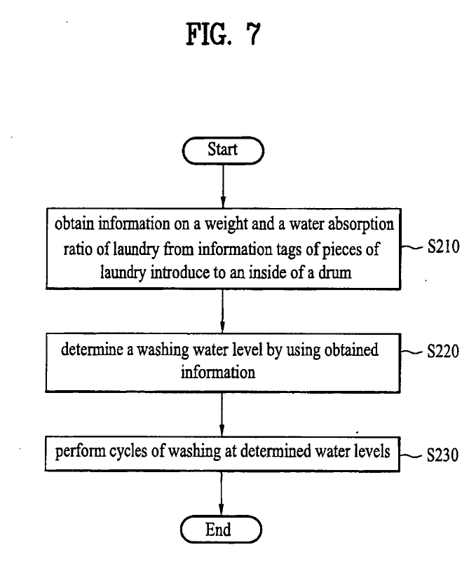

FIG. 7 illustrates a flow chart for describing the steps of a washing method in accordance with a first preferred embodiment of the present invention, wherein the most preferable water level of washing water is fixed with reference to water absorption ratios of the pieces of laundry, which will be described in more detail.

If the user introduces a large number of pieces of laundry to the drum 120, the reader unit 140 obtains information on washing the pieces of laundry from the information tags 21 attached to the pieces of laundry, respectively (S210).

A series of steps for the reader unit 140 to obtain information on washing from the information tag 21 are the same as described before.

Especially, the information on washing obtained thus includes information on weights of the pieces of laundry, and water absorption ratios of the pieces of laundry.

The information having the reader unit 140 obtained according to above steps is provided to the control unit 150, and the control unit 150 determines a washing water level for performing the cycles with reference to the information obtained thus (S220).

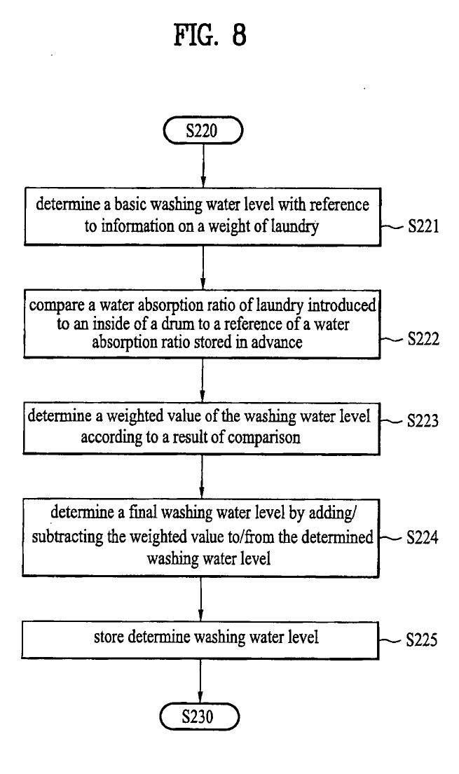

The washing water level is determined with reference to the weights of the pieces of laundry and the water absorption ratios of the pieces of laundry, of which steps will be described in more detail, with reference to the flow chart in FIG. 8.

The control unit 150 determines a basic washing water level with reference to the information on the weights of the pieces of laundry among the information from the reader unit 140 (S221).

The basic washing water level is the washing water level determined with reference to the weight of laundry in the related art.

Along with this, the control unit 150 compares a reference value of the water absorption ratio stored therein in advance to the water absorption ratio of laundry introduced to the drum 120 (S222), and determines a weighted value of the washing water level according to a result of the comparison (S223).

As described before, though it is preferable that the reference value is set such that the weight of the laundry and weight of water the laundry absorbs are the same substantially, the reference value may be set with reference to others as required.

Moreover, there may be a variety of methods for determining the weighted value of the washing water level.

Particularly, in the preferred embodiment of the present invention, the weighted value of the washing water level is determined such that the greater the water absorption ratio of the laundry introduced to the drum 120 compared to the reference value of the water absorption ratio, the greater the weighted value in proportion to the difference, and the smaller the water absorption ratio of the laundry introduced to the drum 120 compared to the reference value of the water absorption ratio, the smaller the weighted value in proportion to the difference.

Moreover, the weighted value may be determined by using above series of steps for every piece of laundry, or by as much as a difference between an average water absorption ratio for entire laundry introduced to the drum 120 and a reference value set in advance, collectively.

Upon finishing determination of the weighted value thus, a final washing water level is determined for each cycle by adding/subtracting washing water supply amount as much as the weighted value determined thus to/from the water level determined with reference to the weight of entire laundry (S224).

Together with this, the control unit 150 stores the washing water level determined thus therein (S225).

Then, as the control unit 150 performs washing related cycles at the determined washing water levels according to a sequence (S300), the washing is made.

In conclusion, the washing method in accordance with a first preferred embodiment of the present invention has an advantage in that the washing is performed at a washing water level that can provide an optimum washing.

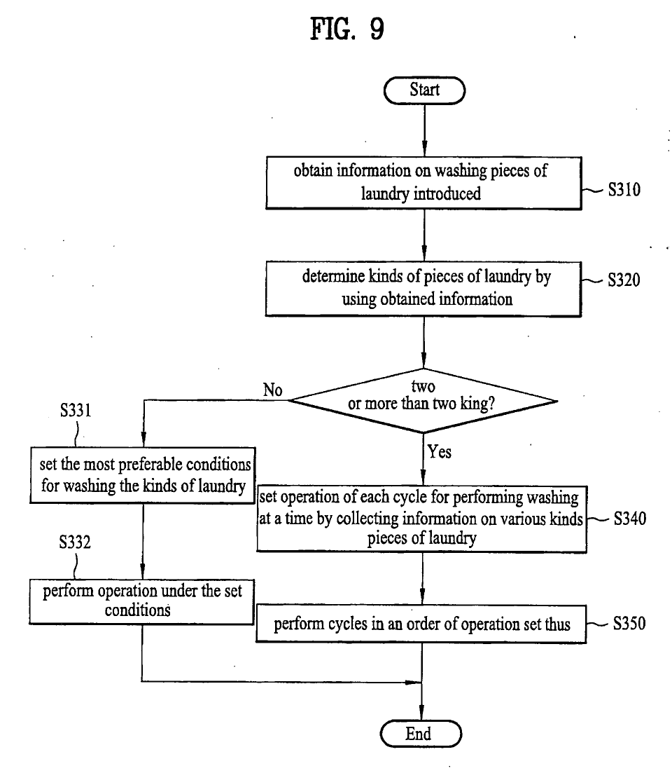

In the meantime, FIG. 9 illustrates a flow chart for describing the steps of a washing method in accordance with a second embodiment of the present invention.

The washing method in accordance with a second embodiment of the present invention enables to perform washing entire pieces of laundry at a time with reference to various kinds of information on washing of the pieces of laundry, which will be described in detail.

Upon introduction of the pieces of laundry to the drum 120, the reader unit 140 obtains information on washing the pieces of laundry from the information tags 210 attached to the pieces of laundry respectively (S310), and provides the information obtained thus to the control unit 150.

A series of steps of obtaining information on washing the pieces of laundry from the information tags 21 are the same as described before.

The information on washing includes at least one of a preferable washing water temperature, a preferable spinning speed, a preferable drying temperature, and a preferable drying time period.

If above step is performed, the control unit 150 determines kinds of the pieces of laundry by using information from the reader unit 140 (S320).

The kinds of pieces of laundry may be kinds of fiber, such as protein fiber, acetate fiber, rayon fiber, or kinds of classification of which conditions are the same or similar, such as a washing time period, a washing temperature, a spinning speed, a drying temperature, and so on.

If it is determined that only same kind of pieces of laundry are introduced, the control unit 150 controls such that a washing proper to the kind of laundry is performed.

That is, the control unit 150 automatically sets to perform an operation which meets conditions of a preferable washing water level, a preferable washing time period, preferable rinsing time period, a preferable spinning speed, a preferable drying temperature, and a preferable drying time period, and so on stored in the information tag 21 of the kind of laundry, and performs operation according to the set conditions.

However, if it is determined that two or more than two kinds of pieces of laundry are introduced, the control unit 150 collects information on washing each kind of pieces of laundry obtained thus, and sets operation for each cycle for washing entire pieces of laundry at a time (S340), and performs cycles according to a sequence of operation of each cycle set thus (S350).

The cycle for washing at a time includes at least one of a washing cycle, a rinsing cycle, a spinning cycle, and a drying cycle.

Particularly, it is preferable that the step for setting operation of each cycle is performed with reference to at least one of a washing time period, a washing temperature, a spinning speed, a drying temperature.

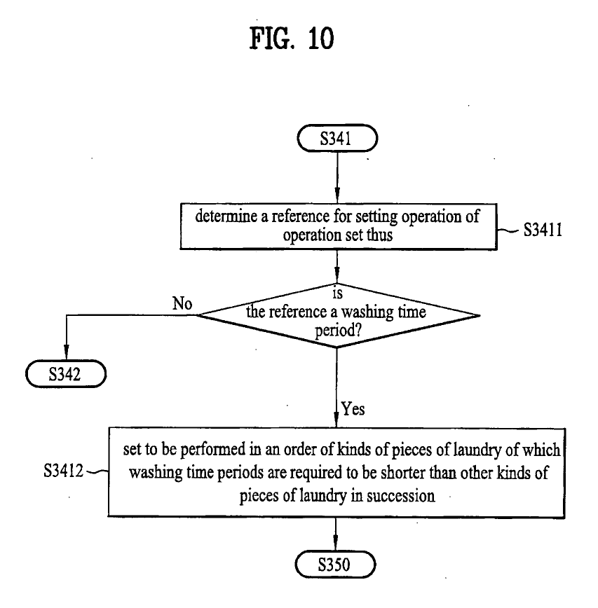

For an example, referring to the step S341 in the attached FIG. 10, in a case the operation for each cycle is required to be set with reference to a washing time period in the step of determining a reference for setting operation of each cycle (S3411), the washing cycle is set to be performed in an order of kinds of pieces of laundry of which washing time periods are required to be the shorter than other kinds of laundry in succession (S3412).

That is, if it is intended to wash a kind of pieces of laundry of fiber of which washing effect is the better as the washing time period is the shorter, and another kind of pieces of laundry of fiber of which washing effect is the better as the washing time period is the longer, mixed therewith, at a time, at first, the washing is performed for a preferable washing time period of the kind of pieces of laundry of which washing time period is required to be shorter, and next, the washing is performed for a preferable washing time period of the kind of pieces of laundry of which washing time period is required to be longer, additionally.

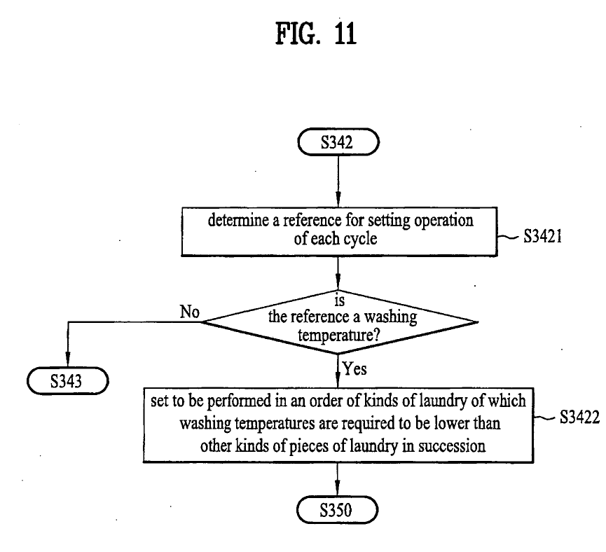

Moreover, referring to the step S342 in the attached FIG. 11, in a case the operation for each cycle is required to be set with reference to a washing temperature in the step of determining a reference for setting operation of each cycle (S3421), the washing cycle is set to be performed in an order of kinds of pieces of laundry of which washing temperatures are required to be the lower than other kinds of pieces of laundry in succession (S3422).

That is, if it is intended to wash a kind of pieces of laundry of fiber of which washing effect is the better as the washing temperature is the lower, and another kind of pieces of laundry of fiber of which washing effect is the better as the washing temperature is the higher, mixed therewith, at a time, at first, the washing is performed at a preferable washing temperature of the kind of pieces of laundry of which washing temperature is required to be lower, and next, the washing is performed at a preferable washing temperature of the kind of pieces of laundry of which washing temperature is required to be higher, additionally.

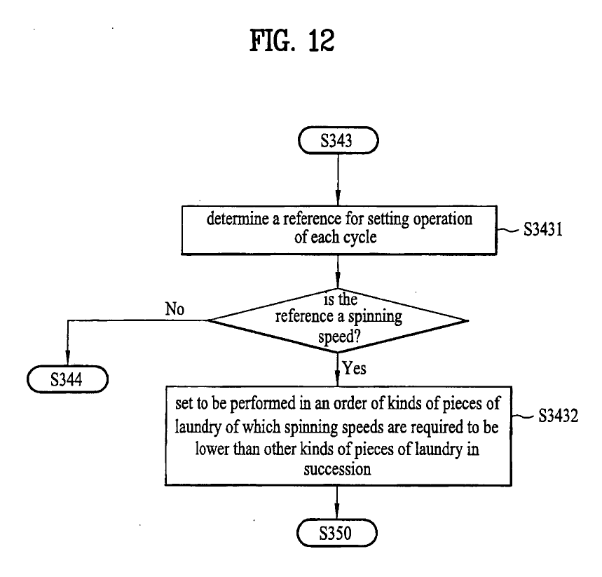

Moreover, referring to the step S433 in the attached FIG. 12, in a case the operation for each cycle is required to be set with reference to a spinning speed in the step of determining a reference for setting operation of each cycle (S3431), the spinning cycle is set to be performed in an order of kinds of pieces of laundry of which spinning speeds are required to be the lower than other kinds of pieces of laundry in succession (S3432).

That is, if it is intended to spin a kind of pieces of laundry of fiber which has no damage thereto only when a spinning speed is low (for an example, fiber susceptible to tear), and another kind of pieces of laundry of fiber which has no damage thereto even if the spinning speed is high, mixed therewith, at a time, at first, the spinning is performed at a preferable spinning speed of the kind of pieces of laundry which has no damage thereto only when a spinning speed is low, and next, the spinning is performed at a preferable spinning speed of the kind of pieces of laundry which does not matter even if the spinning speed is high, additionally.

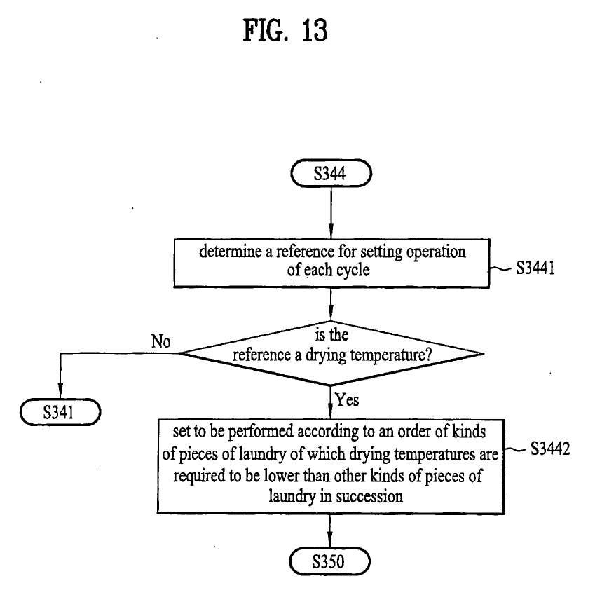

Moreover, referring to the step S344 in the attached FIG. 13, in a case the operation for each cycle is required to be set with reference to a drying temperature in the step of determining a reference for setting operation of each cycle (S3441), the drying cycle is set to be performed according to an order of kinds of pieces of laundry of which drying temperatures are required to be the lower than other kinds of pieces of laundry in succession (S3442).

That is, if it is intended to dry a kind of pieces of laundry of fiber which has no damage thereto only when the drying temperature is low, and another kind of pieces of laundry of fiber which has no damage thereto even if the drying temperature is high, mixed therewith, at a time, at first, the drying is performed at a preferable drying temperature of the kind of pieces of laundry of which drying temperature is required to be lower, and next, the drying is performed at a preferable drying temperature of the kind of pieces of laundry which does not matter even if the drying temperature is high, additionally.

Of course, besides above items, there may be a variety of items of the reference for setting operation of each cycle, such as the rinsing time period, the spinning time period, the drying time period, the soaking time period, and so on.

When the operation of each cycle is performed with reference to the washing time period, the washing temperature, the spinning speed, the drying temperature, and so on thus, in a case the washing, spinning or the drying is performed at first, it is preferable that the control unit 150 gives a notice to the user through the noticing unit 160 that the user takes out laundry of which washing time period is required to be short, laundry of which washing temperature is required to be low, laundry of which spinning speed is required to be low, or laundry of which drying temperature is required to be low, from the drum 120.

In the meantime, a third preferred embodiment of the present invention suggests minimizing inconvenience of the user by reducing classification of kinds of laundry introduced for washing as far as possible.

That is, a washing method in accordance with the third preferred embodiment of the present invention combines kinds of laundry having substantially similar washing conditions for performing washing according to the combined classification in succession.

In this instance, it is preferable that the control unit 150 has a range of each item which can be combined stored therein in advance, such as a predetermined range of the washing time period, a predetermined range of the washing temperature, a predetermined range of the spinning, and a predetermined range of the drying temperature, and so on.

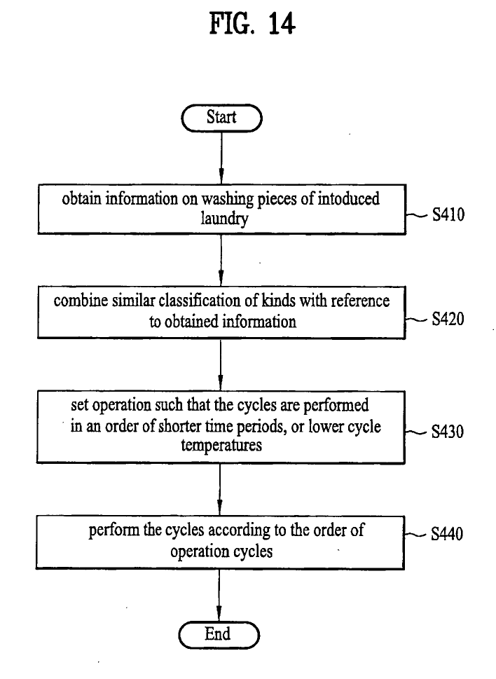

A washing method in accordance with a third embodiment of the present invention will be described in more detail with reference to the flow chart in FIG. 14 attached hereto.

When laundry is introduced to the drum 120, the reader unit 140 obtains information on washing of the laundry from information tags 210 attached to each piece of the laundry (S410), and provides the information to the control unit 150.

The information on washing includes at least one of a preferable temperature, a preferable spinning speed, a preferable drying temperature, a preferable drying time period.

Then, the control unit 150 identifies kinds of the pieces of laundry with information from the reader unit 140, and combines similar classification of kinds (S420).

In this instance, the references for combination of similar classification of kinds are combinable ranges of items, i.e., ranges of washing time periods, ranges of washing temperatures, ranges of spinning speeds, ranges of drying temperatures, and so on.

For an example, in a state the ranges of the washing temperatures are registered in advance at the control unit 150 so as to be classified to be lower than 40° C., and higher than 40° C., if a preferable washing temperature of one piece of laundry (hereafter called as “laundry A”) is lower than 40° C., another preferable washing temperature of another piece of laundry (hereafter called as “laundry B”) is higher than 30° C., and a third preferable washing temperature of a third piece of laundry (hereafter called as “laundry C”) is 60° C., classification of the laundry A and the laundry B are combined as the same class of kind (hereafter called as “A class”), and the laundry C is classified as other class of kind (hereafter called as “B class”).

Then, operation of cycles of the pieces of laundry classified in two classes of kinds are set such that the cycles are performed in an order of shorter cycle time periods, or lower cycle temperatures (S430), and the cycles are performed according to the order of operation cycles set thus (S440).

For an example, after the washing is performed at a temperature proper to the class A, i.e., lower than 40° C., and the washing is performed at a temperature proper to the class B, i.e., higher than 40° C.

In conclusion, the steps of washing method in accordance with the third preferred embodiment of the present invention permits washing a plurality of pieces of laundry at a time while user's inconvenience is minimized.

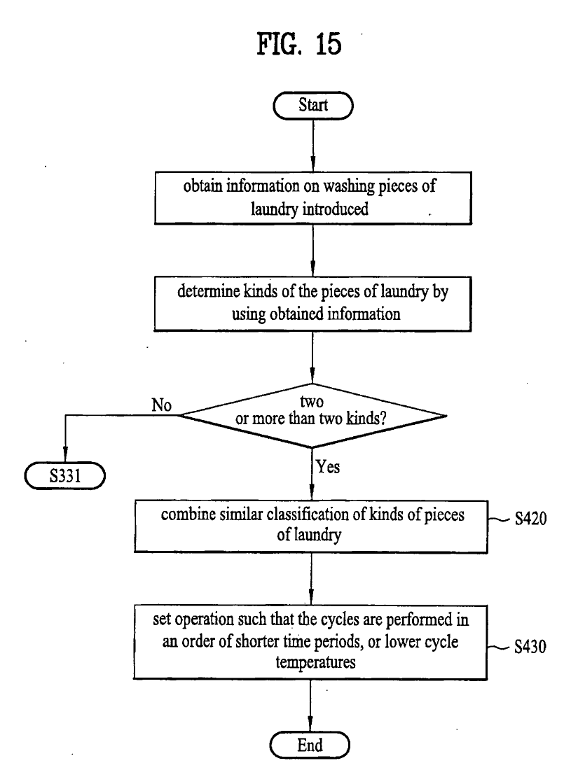

Of course, the third preferred embodiment of the present invention may classify the pieces of laundry into similar kind of classes of pieces of laundry, to set an order of operation of cycles only when a number of kinds of the pieces of laundry are two or more than two as shown in FIG. 15 in the series of step in accordance with the first preferred embodiment of the present invention described before.

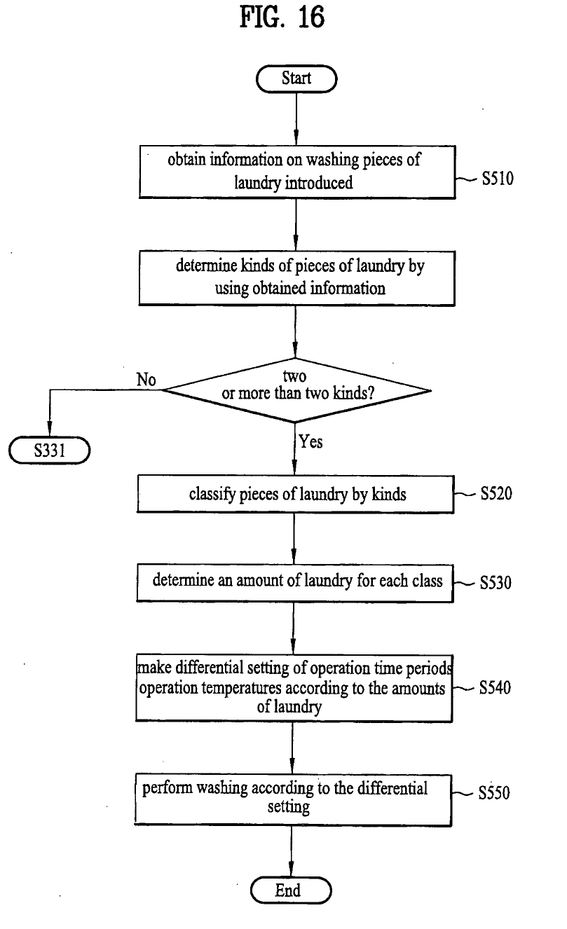

In the meantime, a fourth preferred embodiment of the present invention suggests differential setting of operation for each cycles according to amounts of laundry for each of the classes because the best washing effect can not be obtained if amounts of laundry for each of the classes are not the same even if the pieces of laundry are classified by kinds, which will be described in more detail with reference to the flow chart in FIG. 16 attached hereto.

Information on washing of laundry is obtained from information tags on a plurality of pieces of laundry introduced to the drum 120 (S510).

Then, the control unit classifies the pieces of laundry by kinds with reference to the information obtained thus (S520).

In this instance, it is preferable that the classification of the pieces of laundry is performed only when the pieces of laundry have two of more than two kinds.

Then, the control unit 150 verifies an amount of laundry in each class additionally (S530), to make differential setting of operation time periods, or operation temperatures according to the amounts of laundry (S540).

For an example, as a result of classification of kinds of the pieces of laundry, if the amount of laundry of protein fiber is more than amounts of laundry of other fiber, the operation of the cycle for a low temperature washing time period is set longer than a high temperature washing time period.

Then, the washing is performed according to a differentially set description (S550).

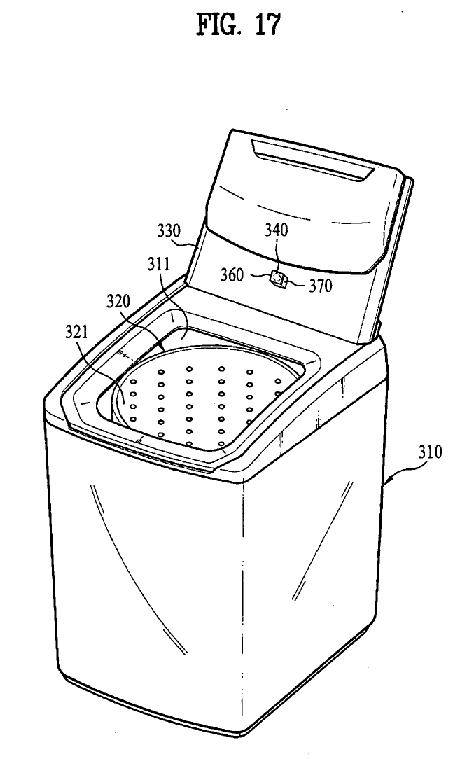

In the meantime, FIGS. 17 to 21 illustrate washing apparatuses in accordance with second to fourth preferred embodiments of the present invention.

The washing apparatuses in accordance with second to fourth preferred embodiments of the present invention illustrate the washing apparatus introduced in the first preferred embodiment of the present invention described before, and the most preferable application of the information transceiver for the washing apparatus, referring to which washing apparatuses in accordance with second to fourth preferred embodiments of the present invention will be described.

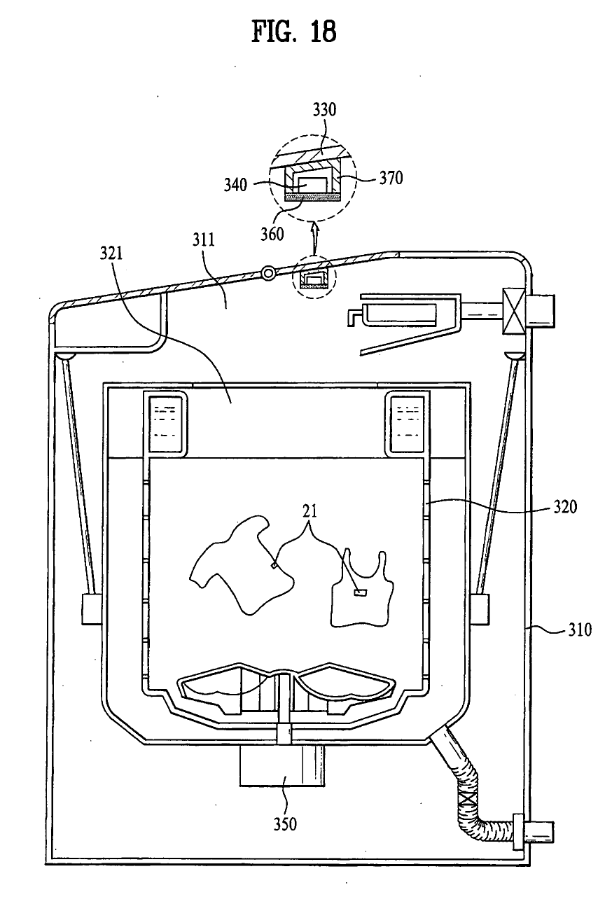

FIGS. 17 and 18 illustrate washing apparatuses in accordance with the second preferred embodiment of the present invention, respectively.

Referring to FIGS. 17 and 18, the washing apparatus includes a body 310, a drum 320, a door unit 330, and a RF reader unit 340. The washing apparatus will be described with reference to a vertical type washing machine, such as a pulsator type washing machine, and the like.

The body 310 forms an exterior of the washing apparatus, and has an opening 311 at a top for introduction of laundry.

The drum 320 is mounted in the body 310 vertically, so as to be rotatable by a driving unit 350.

The drum 320 has an opening 321 in a top for introduction of laundry.

The door unit 330 is mounted to close the opening 311 in the body 310.

The door unit 330 may be mounted so as to be rotatable in a vertical direction, or, as shown as an embodiment, foldable in multi-stages.

Particularly, though the door unit 330 is preferably formed of non-metallic material on the whole, only one portion thereof may be formed of non-metallic material.

The RF reader unit 340 is mounted to the door unit 330, for transmitting through the door unit 330 and obtaining information stored in the RFID tags 21 on the pieces of laundry.

In this instance, it is more preferable that the RF reader unit 340 is mounted on a portion of the door unit 330 formed of non-metallic material, for making transmission/reception of signals with the RFID tags 21, transmitting through the portion of non-metallic material.

It is preferable that the RF reader 340 is mounted on one side of the door unit 330.

Particularly, it is the most preferable that the reader unit 340 is mounted on a side of the body 310 exposed to an outside thereof, for preventing washing water from infiltrating into the RF reader unit 340 as far as possible.

Of course, the RF reader unit 340 may be mounted in a recess in a side of the door unit 330 facing an inside of the drum 320.

In this instance, it is preferable that an infiltration prevention unit 360 is further provided between the RF reader unit 340 and the drum 320 for allowing transmission of signal from the RF reader unit 340 therethrough, while preventing washing water from infiltrating into the RF reader unit 340 from the drum.

It is preferable that the infiltration prevention unit 360 is formed of non-metallic material, and more preferably, of sealant which prevents infiltration of water.

Accordingly, when the user intends to perform washing, the user can obtain information on the pieces of laundry in the drum 320 simply by a series of steps of introduction of the pieces of laundry into the drum 320, and closing the door unit 330.

That is, as the RF reader unit 340 is mounted at a position where there is no interference of transmission/reception of the RF signal with the drum 320 of metal, and at a portion where there is no water infiltration at the time of washing, the reader unit 340 has an advantage in that the pieces of laundry are not required to be brought close to the RF reader unit 340 one by one, for sensing.

However, since above described series of structure are liable to take information on pieces of laundry even the user wears in the vicinity of the washing apparatus for introduction of the laundry, a problem can be caused in which an exact sensing of the pieces of laundry is not possible.

Therefore, it is more preferable that the reader unit 340 further includes a shielding portion 370 around a portion thereof exposed to an outside of the body 310 for preventing leakage of a signal from the reader unit 340 toward an outside of the body 310.

The shielding portion 370 is formed of metal, and it is the most preferable that the shielding portion 370 can provide a direction to the RF signal.

That is, the RF reader unit 340 is designed such that the signal from the RF reader unit 340 can only be directed to an inside of the drum 320, for preventing the reader unit 340 form reading information on the laundry the user wears coming closer thereto from an outside of the body 310.

Of course, it does not matters even if the shielding portion 370 is not formed of metal as far as the shielding portion 370 is formed of a material that can shield the transmission/reception of the RF signal.

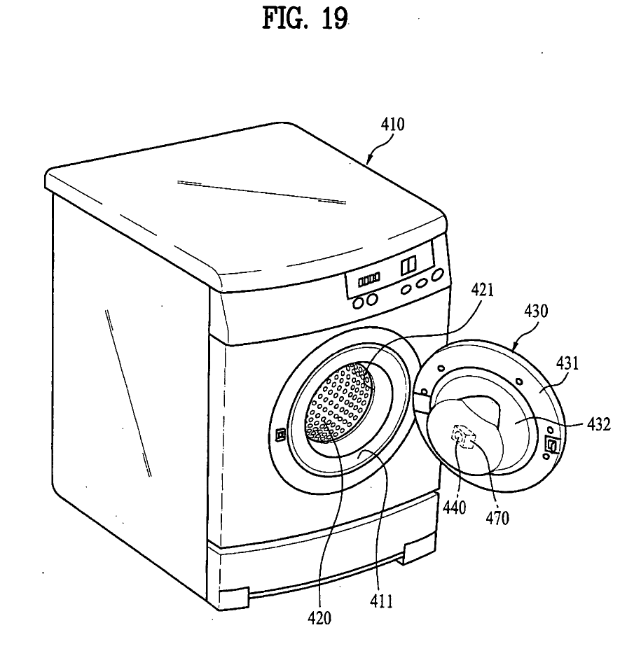

In the meantime, FIG. 19 illustrates a perspective view of a washing apparatus in accordance with a third preferred embodiment of the present invention.

That is, the washing apparatus in accordance with the third preferred embodiment of the present invention illustrates application of a mounting structure of the RF reader unit in accordance with an aspect of the present invention to a drum type washing machine, of which structure will be described in more detail.

The washing apparatus in accordance with the third preferred embodiment of the present invention includes a body 410, a drum 420, a door unit 430, and a RF reader unit 440.

The body 410 forms an exterior of the drum type washing machine, and has an opening 411 in a front.

The drum 420 is rotatably mounted in a horizontal direction in the body 410, and has an opening 421 opposite to the opening 411 in the body 410 for introduction of laundry thereto.

The door unit 430 is mounted so as to close the opening 411 in the body 410 selectively, and has at least one portion formed of non-metallic material.

The door unit 430 includes a door frame 431 forming an exterior, and a door glass 432 of a material enabling see-through to an inside portion of the drum 420 secured to an inside of the door frame 431.

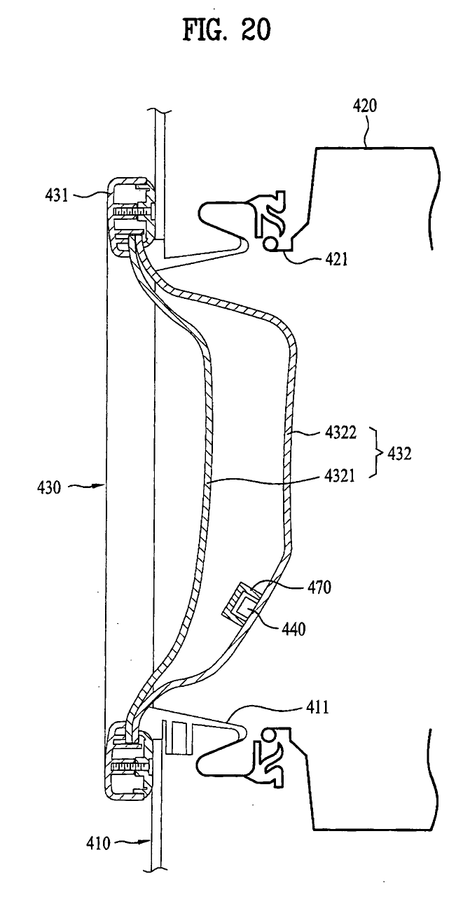

Though the door glass 432 may have a single layer, in general, the door glass 432 has one pair of glass pieces 4321 and 4322 spaced a predetermined from each other as shown in FIG. 20.

The RF reader unit 440 is mounted on a non-metallic portion of the door unit 430, for obtaining information from the RFID tags on pieces of laundry transmitting through the non-metallic portion.

It is preferable that the RF reader unit 440 is mounted on a portion of the door glass 432 of the door unit 430 which enables transmission/reception of a signal to/from entire region of an inside of the drum 420.

Particularly, it is preferable that the RF reader unit 440 is mounted to reduce sensing errors by mounting the RF reader unit 440 close to the piece of laundry introduced to the drum as far as possible.

According to this, the third preferred embodiment of the present invention suggests to mount the RF reader unit 440 on a lower side of the door glass 432.

The RF reader unit 440 is mounted on one of sides of the door glass 432, particularly, as shown in FIG. 20, on a side of the inner door glass 4322 between the one pair of glasses 4321, and 4322, i.e., opposite to a side exposed to the inside of the drum 420, preferably.

Of course, the RF reader unit 440 may be mounted on the outer door glass 4321 exposed to an outside of the body 410.

Moreover, the RF reader unit 440 may be mounted in a recess in a side of the one pair of door glasses 432 facing the inside of the drum 420. However, in this case, it is required to prevent washing water from infiltrating into a place where the RF reader unit 440 is mounted thereon.

Moreover, it is preferable that a shielding portion 470 is further provided to an outside circumference of the RF reader unit 440 for preventing leakage of a signal from the RF reader unit 440 toward an outside of the body 410.

In this instance, the shielding portion 470 is preferably formed of metal.

This is for preventing the RF reader unit 440 from sensing the laundry the user wears.

In conclusion, by providing the best mode of application of the drum type washing machine, the third preferred embodiment of the present invention can improve a sensing ratio of the pieces of laundry introduced to the drum 420 and prevent occurrence of a sensing error.

That is, in a state the door unit 430 is closed on the opening 411 of the body 410, by transmitting a RF signal to the inside of the drum 420 through the door glass 432, the RF reader unit 440 obtains information on washing stored in the RFID tags 21 on the pieces of laundry in the drum 420.

Especially, the RF reader unit 440 has an advantage in that bringing of the pieces of laundry close to the RF reader unit 440 one by one is not required by mounting the RF reader unit 440 at a position where the RF signal transmission/reception is not interfered with the drum 420 of metal, as well as infiltration of washing water is prevented at the time of washing.

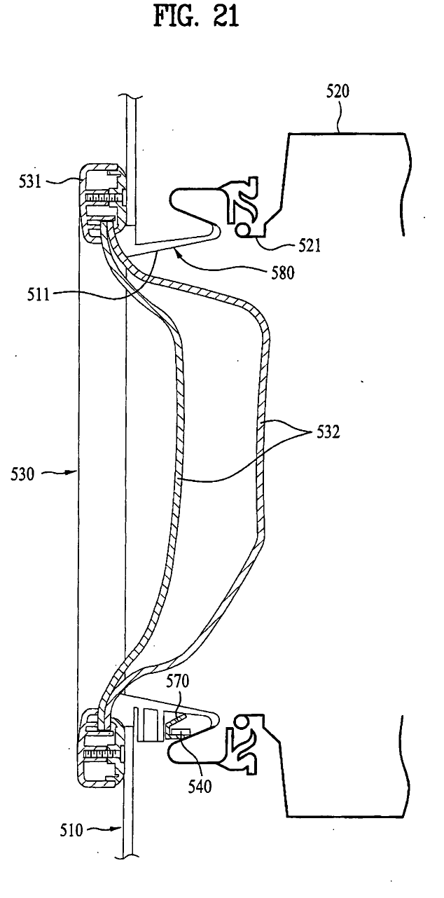

In the meantime, FIG. 21 illustrates a washing apparatus in accordance with a fourth preferred embodiment of the present invention.

That is, the washing apparatus in accordance with a fourth preferred embodiment of the present invention suggests mounting of the RF reader unit at a position where exact sensing of the RFID tags attached to the pieces of laundry is possible and the RF reader is invisible, i.e., a position except the door unit.

This is because the RF reader unit mounted on the door glass of the door unit is liable to cause complaint of the consumers that it is not good in view of the effect of sense of sight.

That is, while the door glass is provided for permitting see-through to the inside of the drum, the RF reader unit mounted at a portion of the door glass may impede the see-though to the inside of the drum.

Of course, though it does not matters if a size of the RF reader unit becomes smaller substantially, it is the most preferable that the RF reader unit is mounted at a position where the size of the RF reader unit is taken into account.

The washing apparatus in accordance with a fourth preferred embodiment of the present invention will be described in more detail with reference to FIG. 21 attached hereto.

The washing apparatus in accordance with the fourth preferred embodiment of the present invention includes a body 510, a drum 520, a door unit 530, a rim portion 580, and a RF reader unit 540.

The body 510 forms an exterior of the drum type washing machine, and has an opening 511 in a front.

The drum 520 is rotatably mounted in a horizontal direction in the body 510, and has an opening 521 opposite to the opening 511 in the body 510 for introduction of laundry thereto.

The door unit 530 is mounted so as to close the opening 511 in the body 510 selectively, and has at least one portion formed of non-metallic material.

The door unit 530 includes a door frame 531 forming an exterior, and a door glass 532 of a material enabling see-through to an inside portion of the drum 520 secured to an inside of the door frame 531.

The rim portion 580 is provided between, and along circumferences of the opening 511 in the body 510 and the opening 521 in the drum 520, for closing a gap between the body 510 and the drum 520.

The rim portion 580 is formed of non-metallic material, in general, rubber.

The RF reader unit 540 is mounted on an inside of the body 510, for obtaining information from the RFID tags 21 on pieces of laundry in the drum 520 transmitting through the rim portion 580.

It is preferable that the RF reader unit 540 is mounted on a side of the rim portion 580 opposite to a side of the rim portion 580 exposed to the opening 521 of the drum 520, for preventing exposure of the RF reader unit 540 to a washing water flow path particularly, it is preferable that a shielding portion 570 is further provided to an outside circumference of the RF reader unit 440 for preventing leakage of a signal from the RF reader unit 540 toward an outside of the body.

In this instance, the shielding portion 570 is preferably formed of metal.

This is for preventing the RF reader unit 440 from sensing the laundry the user wears.

In conclusion, owing to the mounting structure of the RF reader unit 540, the fourth preferred embodiment of the present invention can meet the requirement for the effect of sense of sight to the maximum, and prevent occurrence of a sensing error of the clothes introduced to the drum 520.

That is, in a state the door unit 530 is closed on the opening 511 of the body 510, by transmitting a RF signal to the inside of the drum 420 through the rim portion 580, the RF reader unit 540 obtains information on washing stored in the RFID tags 21 on the pieces of laundry in the drum 520.

Especially, the RF reader unit 440 has an advantage in that bringing of the pieces of laundry close to the RF reader unit 540 one by one is not required by mounting the RF reader unit 540 at a position where the RF signal transmission/reception is not interfered with the drum 520 of metal, as well as infiltration of washing water is prevented at the time of washing.

### INDUSTRIAL APPLICABILITY

Since one mode of the present invention provides a structure of an information transceiver for a washing apparatus, the present invention is applicable to an industry.

Since another mode of the present invention provides a structure of a washing apparatus having a RFID reader unit applied thereto in the most preferable fashion, and a washing method by using the same, the present invention is applicable to an industry.

Since another mode of the present invention provides a structure of a washing apparatus, and a washing method by using the same, which permit to obtain information on the pieces of laundry at a time, and to perform the most preferable washing by using the information obtained thus, the present invention is applicable to an industry.

1. An information transceiver for a washing apparatus comprising:
a RFID Tag (Radio Frequency Identification Tag) fastened to a portion of each piece of laundry, the RFID Tag having information on the piece of laundry stored therein;
a RF reader unit mounted to a portion of the washing apparatus, for transmitting/receiving information to/from the pieces of laundry introduced to the washing apparatus at a time by a mutual induction system; and
a control unit for performing setting of at least one cycle of washing operation with reference to various kinds of information on the laundry received from the RF reader unit.

2. The information transceiver as claimed in claim 1, wherein the RFID tag includes a RFID chip, a coil antenna, and water proof films.

3. The information transceiver as claimed in claim 1, wherein the RFID tag can identify information stored therein and receive additional information.

4. The information transceiver as claimed in claim 1, wherein the RFID tag is a passive type tag which rectifies an electric wave signal from the RF reader unit for using as a power source.

5. The information transceiver as claimed in claim 1, wherein the RFID tag is detachable from the piece of laundry as necessary.

6. The information transceiver as claimed in claim 1, wherein the RF reader unit and the control unit are fabricated as one unit.

7. The information transceiver as claimed in claim 1, wherein the RF reader unit and the control unit are fabricated as separate type, and the control unit can control operation of the washing apparatus.

8. The information transceiver as claimed in claim 1, wherein the RF reader unit includes;
a reader antenna for exchanging a signal with the RFID tag, and a RF module for analyzing, and integrating information on the RFID tag received through the reader antenna.

9. The information transceiver as claimed in claim 1, wherein the washing apparatus includes a body forming an exterior thereof, a drum in the body for performing washing or drying cycle in a state the laundry is introduced thereto, and a driving unit for driving the drum, and
the RF reader unit is mounted to a position within approx. 1 m from a position where the laundry is introduced to the drum.

10. A washing apparatus comprising:
a reader unit for receiving a signal from an information tag on each piece of laundry, to obtain information on washing the piece of laundry stored in the information tag; and
a control unit for performing setting of at least one cycle of washing operation with reference to the information on washing the piece of laundry obtained from the reader unit, and controlling to perform washing according to a set cycle.

11. The washing apparatus as claimed in claim 10, wherein the information tag is a RFID tag which has various kinds of information stored therein, and can write information additionally, and
the reader unit is a RFID reader which can perform transmission/reception of information to/from the RFID tag at a time by a mutual induction system, or write new information on the RFID tag.

12. The washing apparatus as claimed in claim 10, wherein the information on washing stored in the information tag on each piece of laundry includes at least one kind of information selected from a washing temperature, a spinning speed, a drying temperature, a drying time period, a weight of the laundry, a water absorption ratio.

13. A washing apparatus comprising:
a body forming an exterior, the body having an opening;
a drum rotatably mounted in the body, the drum having an opening for introducing laundry thereto;
a door unit for closing the opening, having at least a portion formed of non-metallic material; and
a RF reader unit mounted on a non-metallic portion of the door unit, for obtaining information from a RFID tag on each piece of laundry transmitting through the door unit.

14. The washing apparatus as claimed in claim 13, wherein the RF reader unit is mounted on at least one side of the non-metallic portion of the door unit.

15. The washing apparatus as claimed in claim 14, wherein the door unit includes;
a door frame forming an exterior of the door unit, and
a door glass formed of a material which enables see-through to an inside of the drum, and mounted on an inside of the door frame; and
the RF reader is mounted on the door glass.

16. The washing apparatus as claimed in claim 15, wherein the RF reader unit is mounted on a lower side of a center side of the door glass.

17. The washing apparatus as claimed in claim 15, wherein the RF reader unit is mounted on a side of the door glass exposed to an outside of the body.

18. The washing apparatus as claimed in claim 15, wherein the RF reader unit is mounted in a recess in a side facing an inside of the drum.

19. The washing apparatus as claimed in claim 18, further comprising an infiltration prevention unit between the RF reader unit and the drum, for enabling transmission of a signal from the RF reader unit, while preventing washing water from infiltrating into the RF reader unit from the drum.

20. The washing apparatus as claimed in claim 13, further comprising a signal shielding portion around an outside circumference of the RF reader unit for preventing a signal from leaking to an outside of the body from the RF reader unit.

21. The washing apparatus as claimed in claim 20, wherein the signal shielding portion is formed of metal.

22. The washing apparatus as claimed in claim 13, wherein the opening in the body is formed in a front side of the body, and
the drum is mounted in the body rotatable along a horizontal direction such that an opening in the drum is opposite to the opening.

23. The washing apparatus as claimed in claim 13, wherein the opening in the body is formed in a top side of the body, and the drum is mounted so as to be rotatable in an upstanding state such that the opening in the drum is opposite to the opening.

24. A washing apparatus comprising:
a body forming an exterior, the body having an opening;
a drum rotatably mounted in the body, the drum having an opening for introducing laundry thereto;
a door unit for closing the opening;
a rim portion of non-metallic material between the opening in the body and the opening in the drum for closing a gap between the drum and the inside of the body; and
a RF reader unit mounted on an inside of the body, for obtaining information from a RFID tag on each piece of laundry transmitting through the rim portion.

25. The washing apparatus as claimed in claim 24, wherein the RF reader unit is mounted on a side of the rim portion exposed to an outside of the body.

26. The washing apparatus as claimed in claim 24, further comprising a signal shielding portion on an outside circumference of the RF reader unit for preventing a signal from leaking to an outside of the body from the RF reader unit.

27. The washing apparatus as claimed in claim 26, wherein the signal shielding portion is formed of metal.

28. A washing method comprising:
an information obtaining step for obtaining information on a weight and a water absorption ratio of a piece of laundry from an information tag on the piece of laundry introduced to the drum by using a reader unit;
a water level determining step for determining a water level with reference to the information obtained thus; and
a cycle performing step for performing washing related cycles at the washing level in succession.

29. The washing method as claimed in claim 28, wherein the water level determining step includes the steps of;
determining a washing water level corresponding to a weight of laundry,
comparing a preset reference of the water absorption ratio to a water absorption ratio of the laundry in the drum obtained through the reader unit, and determining a weighted value of the washing water level according to a result of the comparison, and
adding/subtracting washing water supply amount as much as the weighted value determined thus to/from the water level determined above to determine a final washing water level for each cycle.

30. The washing method as claimed in claim 29, wherein the water absorption ratio is determined with reference to a fact that a weight of the laundry is substantially the same with a weight of water the laundry absorbs.

31. The washing method as claimed in claim 29, wherein the weighted value of the washing water level is determined such that the greater the water absorption ratio of the laundry introduced to the drum compared to the reference value of the water absorption ratio, the greater the weighted value in proportion to the difference, and the smaller the water absorption ratio of the laundry introduced to the drum compared to the reference value of the water absorption ratio, the smaller the weighted value in proportion to the difference.

32. A washing method comprising:
a laundry introducing step for introducing laundry to an inside of a drum;
a drum rotating step for rotating the drum; and
an information obtaining step for putting a reader unit into operation to obtain various kinds of information from an information tag on each piece of laundry in a drum which is rotating.

33. The washing method as claimed in claim 32, wherein the drum rotating step includes the step of rotating the drum at a rotating speed the same or lower than a rotating speed of the drum at the time of a washing.

34. The washing method as claimed in claim 32, wherein the information obtaining step includes the step of the reader unit being operated to prevent the reader unit from obtaining information from the information tag on the piece of laundry having information obtained therefrom already, again.

35. The washing method as claimed in claim 34, wherein the step of preventing the reader unit from obtaining information again includes the steps of;
determining whether the information tag has predetermined sensing finish information stored therein or not, and
as a result of above determination, if the sensing finish information is stored therein, no information obtaining is performed for the information tag, and if no sensing finish information is stored therein, information on washing is obtained from the information tag, and the sensing finish information is provided thereto.

36. A washing method comprising:
a laundry introducing step for introducing laundry to an inside of a drum;
an information determining step for putting a reader unit into operation to determine whether predetermined sensing finish information is stored in the tag of each piece of laundry introduced to an inside of drum; and
if no sensing finish information is stored therein, information on washing of the piece of laundry is obtained from the information tag, and the sensing finish information is provided thereto.

37. The washing method as claimed in claim 35, wherein the sensing finish information is stored in the information tag with one of numerals, characters, symbols, and codes.

38. The washing method as claimed in claim 35, further comprising the step of erasing the sensing finish information stored in the information tag once the obtaining information is finished by the reader unit.

39. A washing method comprising:
an information obtaining step for obtaining information on washing pieces of laundry from each information tag on each of the pieces of laundry introduced to an inside of a drum;
an operation setting step for setting operation of each cycle for washing entire pieces of laundry at a time with reference to information on washing obtained thus; and
performing washing in an order of operation cycles set thus.

40. The washing method as claimed in claim 39, wherein the information on washing obtained in the information obtaining step includes at least one of a washing temperature, a spinning speed, a drying temperature, a drying time period.

41. The washing method as claimed in claim 39, wherein the cycle in the operation setting step includes at least one of washing cycle, rinsing cycle, spinning cycle, and drying cycle.

42. The washing method as claimed in claim 39, wherein the operation set in the operation setting step is performed with reference to at least one of washing time period, washing temperature, spinning speed, drying temperature.

43. The washing method as claimed in claim 42, wherein, if the operation of each cycle is set with reference to the washing time period, the washing cycle is set to be performed in an order of kinds of pieces of laundry of which washing time periods are required to be the shorter than other kinds of pieces of laundry in succession.

44. The washing method as claimed in claim 43, further comprising the step of giving a notice to a user that the user takes out laundry of which washing time period is required to be the shortest relative to other laundry.

45. The washing method as claimed in claim 42, wherein, if the operation of each cycle is set with reference to the washing temperature, the washing cycle is set to be performed in an order of kinds of pieces of laundry of which washing temperatures are required to be the lower than other kinds of pieces of laundry in succession.

46. The washing method as claimed in claim 45, wherein, upon finishing washing of laundry of which washing cycle is required to be performed in a state a washing temperature thereof is relatively lower compared to other laundry, a control is made to increase a temperature of washing water to the next temperature range without stopping the cycle, to enable performance of continuous washing.

47. The washing method as claimed in claim 45, further comprising the step of giving a notice to the user to take the laundry out of the drum upon finishing washing of laundry of which washing cycle is required to be performed in a state a washing temperature thereof is relatively lower compared to other laundry.

48. The washing method as claimed in claim 42, wherein, if the operation of each cycle is set with reference to the spinning speed, the spinning cycle is set to be performed in an order of kinds of pieces of laundry of which spinning speeds are required to be the lower than other kinds of pieces of laundry in succession.

49. The washing method as claimed in claim 48, wherein, upon finishing spinning of laundry of which spinning cycle is required to be performed in a state the spinning speed thereof is relatively lower compared to other laundry, a control is made to increase a rotation speed of the drum to the next spinning speed range without stopping the cycle, to enable performance of continuous spinning.

50. The washing method as claimed in claim 48, further comprising the step of giving a notice to the user to take the laundry out of the drum upon finishing spinning of laundry of which spinning cycle is required to be performed in a state the spinning speed thereof is relatively lower compared to other laundry.

51. The washing method as claimed in claim 42, wherein, if the operation of each cycle is set with reference to the drying temperature, the drying cycle is set to be performed in an order of kinds of pieces of laundry of which drying temperatures are required to be the lower than other kinds of pieces of laundry in succession.

52. The washing method as claimed in claim 51, further comprising the step of giving a notice to the user to take the laundry out of the drum upon finishing drying of laundry of which drying cycle is required to be performed in a state the drying temperature thereof is relatively lower compared to other laundry.

53. The washing method as claimed in claim 39, wherein, the operation setting step and the step thereafter are performed only when two or more than two kinds of laundry are introduced as a result of determination of information on the pieces of laundry obtained through the information obtaining step.

54. The washing method as claimed in claim 39, further comprising the step of classifying similar kinds of pieces of laundry with reference to information on laundry obtained thus before performing the operation setting step after finish of the information obtaining step.

55. The washing method as claimed in claim 54, wherein the similar kinds of pieces of laundry are at least one kind which can be classified according to kinds of fiber, such as kinds of protein fiber, kinds of acetate fiber, and kinds of rayon fiber.

56. The washing method as claimed in claim 54, wherein the similar kinds of pieces of laundry are at least one kind which can be classified according to washing conditions, such as the washing time period, the washing temperature, the spinning speed, and the drying temperature.

57. The washing method as claimed in claim 54, further comprising the steps of:
determining amounts of laundry for each classification of the pieces of laundry classified into similar kinds; and
making differential setting of cycle time periods or cycle temperatures according to the amounts of laundry for each classification determined thus.

58. A washing method comprising:
an information obtaining step for obtaining information on washing pieces of laundry from each information tag on each of the pieces of laundry introduced to an inside of a drum;
a classifying step for classifying the pieces of laundry into similar kinds with reference to the information on washing obtained thus;
an operation order setting step for setting an order of operation of each cycle such that the cycles are performed in an order of the kinds of pieces of laundry classified thus of which cycle time periods are the shorter, or cycle temperatures are the lower in succession; and
a cycle performing step for performing cycles in an order of operation cycles set thus.

59. The washing method as claimed in claim 58, wherein the similar kinds of pieces of laundry are at least one kind which can be classified according to kinds of fiber, such as kinds of protein fiber, kinds of acetate fiber, and kinds of rayon fiber.

60. The washing method as claimed in claim 58, wherein the similar kinds of pieces of laundry are at least one kind which can be classified according to washing conditions, such as the washing time period, the washing temperature, the spinning speed, and the drying temperature.

61. The washing method as claimed in claim 58, further comprising the steps of:
determining amounts of laundry for each classification of the pieces of laundry classified into similar kinds; and
making differential setting of cycle time periods or cycle temperatures according to the amounts of laundry for each classification determined thus.

62. A washing method comprising:
an information obtaining step for obtaining information on washing pieces of laundry from each information tag on each of the pieces of laundry introduced to an inside of a drum;
a classifying step for classifying the pieces of laundry into similar kinds with reference to the information on washing obtained thus;
a washing amount determining step for determining amounts of pieces of laundry classified into similar kinds;
an operation setting step for making differential setting of cycle time periods or cycle temperatures according to the amounts of the pieces of laundry classified into similar kinds determined thus; and
a cycle performing step for performing cycles in an order of operation cycles set thus.

63. The washing method as claimed in claim 62, wherein the operation setting step includes the step of setting a low temperature washing time period to be performed longer than a high temperature washing time period, if an amount of laundry classified as protein fiber is greater than an amount of laundry classified as other fiber.

64. The washing method as claimed in claim 36, wherein the sensing finish information is stored in the information tag with one of numerals, characters, symbols, and codes.

65. The washing method as claimed in claim 36, further comprising the step of erasing the sensing finish information stored in the information tag once the obtaining information is finished by the reader unit.
